(19) United States
(12) Patent Application Publication
(10) Pub. No.: US 2010/0075794 A1
(43) Pub. Date: Mar. 25, 2010

(54) TRANSMISSION ACTUATION SYSTEM

(75) Inventors: Trevor McConnell, Rittman, OH (US); Jeffrey Hemphill, Copley, OH (US); Philip George, Wooster, OH (US)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/564,364

(22) Filed: Sep. 22, 2009

Related U.S. Application Data
(60) Provisional application No. 61/194,077, filed on Sep. 24, 2008.

(51) Int. Cl. F16H 61/30

(52) U.S. Cl. 475/146

(57) ABSTRACT

A transmission system without dynamic seals, specifically, an actuator for a vehicle transmission including a first rotating clutch pack engageable with a planetary gearset a first non-rotating actuator piston for engaging the clutch pack and a first bearing for isolating a first rotation of the clutch pack from the piston. A transmission system is provided using an electromechanical system for shifting the clutches, allowing a smaller pump only for lubrication of the transmission and the torque converter flow.

### FIELD OF THE INVENTION

The invention relates generally to a transmission actuator, and more specifically to a transmission actuator without rotational seals.

### BACKGROUND OF THE INVENTION

Conventional automatic transmissions select gears using a combination of planetary gearsets and torque-transmitting mechanisms. For instance, U.S. Pat. No. 6,932,765 (Kao et al), assigned to General Motors, describes six-speed planetary transmission mechanisms with three planetary gearsets, two clutches and three brakes. Each family member may be employed in a power train to provide six forward speed rations and one reverse speed ration when the torque-transmitting mechanisms are engaged in combinations of two in a selected manner.

As disclosed in U.S. Pat. No. 6,960,150 (Armstrong et al), assigned to General Motors, torque-transmitting mechanisms include piston mechanisms, which are slidably disposed within members of the transmission housing including a front end cover, a rear end cover, and a shell interconnecting the front end cover and the rear end cover. As can be seen in the transmission depicted in FIGS. 1 and 2, rear end cover 10 has extension or boss 12, which rotatably supports sleeve portion 14 of input shaft 16. Extension 12 and sleeve portion 14 include a plurality of hydraulic passages through which fluid to torque-transmitting mechanisms 18 and 20 is directed.

Extension 12 is a portion of stationary cover 10 and sleeve 14 is a portion of rotating input shaft 16. Therefore, seals forming a portion of the hydraulic passage between extension 12 and sleeve 14 must be dynamic or rotational seals. That is, because there is relative rotation between extension 12 and sleeve 14 during operation of the transmission, the seals must be dynamic or rotational seals.

Similarly, in the transmission depicted in FIGS. 3 and 4, cover 50 has extension or boss 52, which rotatably supports sealing portion 54 of input shaft 56. Extension 52 and sleeve portion 54 include a plurality of hydraulic passages through which fluid to the torque-transmitting mechanisms 58 and 60 is directed. Extension 52 is a portion of stationary cover 50 and portion 54 is a portion of rotating input shaft 56. Therefore, seals forming a portion of the hydraulic passage between extension 52 and portion 54 must be dynamic or rotational seals. That is, because there is relative rotation between extension 52 and portion 54 during operation of the transmission, the seals must be dynamic or rotational seals.

It should be appreciated that the current state-of-the-art uses hydraulic pressure from a pump to control the clutches in the transmission and torque converter, providing lubrication and cooling for the bearings in gears within the transmission, and provide fluid flow to the torque converter. The flow from the pump is routed to a valve body which divides the flow between the proper clutches and lubrication/cooling circuits, and the torque converter. By nature, these tasks have conflicting requirements. The clutch circuits require high pressure and low flow while the lubrication and torque converter flow requires high flow and low pressure. Therefore the design of this pump and related hydraulics requires a trade off to perform all of these tests.

While generally sufficient to engage the piston mechanisms, dynamic seals are not liquid-tight seals and allow some leakage of hydraulic fluid past the sealing interface. This leakage results in lower transmission efficiency because the transmission pump must continually operate to ensure that the torque-transmitting mechanisms do not slip. Thus there is a long-felt need for a transmission actuator without dynamic seals.

### BRIEF SUMMARY OF THE INVENTION

The present invention broadly comprises a transmission system without dynamic seals, specifically, an actuator for a vehicle transmission including a first rotating clutch pack engageable with a planetary gearset a first non-rotating actuator piston for engaging the clutch pack and a first bearing for isolating a first rotation of the clutch pack from the piston. A transmission system is provided using an electromechanical system for shifting the clutches, allowing a smaller pump only for lubrication of the transmission and the torque converter flow.

In one embodiment, the transmission system includes a torque converter and a pump operatively arranged for only providing lubrication to the transmission system and the torque converter, wherein the pump includes a sump for storing a lubricant, an apply actuator, a supply actuator, and a plurality of passageways connecting the sump, the apply actuator, the supply actuator, and the transmission system for distributing the lubricant throughout the transmission system, wherein the apply actuator controls which passageways are open for running a master cylinder which pressurizes the system, and wherein the release actuator controls which passageways are open for returning the lubricant back to the sump.

In a preferred embodiment, the apply actuator opens passageways by rotating a series of gears to align openings in the gears with valve spools, wherein there is one valve spool provided in each passageway for restricting or enabling flow as determined by the alignment of the gears. In another embodiment the release actuator opens selected passageways by rotating a cylinder to align openings in the cylinder with the passage ways.

A general object of this invention is to provide a transmission actuator without dynamic seals. Another object is to optimize the system by using an electromechanical system for shifting the clutches, allowing a smaller pump only for lubrication of the transmission and the torque converter flow. This optimized pump can be smaller and therefore result in lower operating losses in the system and greater overall fuel economy.

Another object of the invention is to remove clutch operation from the requirement of the pump.

Still another object of the invention is to use electromechanical actuation to operate the transmission clutches.

Yet another object of the invention is to use only to electric motors to actuate the entire transmission.

Yet a further object of the invention is to provide a transmission actuation system that works with existing transmission architectures.

These and other objects, features and advantages of the present invention will become readily apparent and appreciated by those having ordinary skill in the art in view of the following detailed description of the invention, claims to the invention, and several views of the drawings.

### BRIEF DESCRIPTION OF THE DRAWINGS

The nature and mode of operation of the present invention will now be more fully described in the following detailed description of the invention taken with the accompanying drawing figures, in which:

FIG. 1 is a cross-section of a first transmission;

FIG. 2 is a detail view of encircled region 2 in FIG. 1;

FIG. 3 is a cross-section of a second transmission;

FIG. 4 is a cross-section of encircled region 4 in FIG. 3;

FIG. 5 is a detail view of encircled region 2 with an example embodiment of a present invention actuator;

FIG. 6 is a detail view of encircled region 4 with an example embodiment of a present invention actuator;

FIG. 7 is a sectioned perspective view of an actuator motor and hydraulic cylinder according to an example embodiment of the present invention;

FIG. 8 is a top view of a gear drive for the actuator of FIG. 7;

FIG. 9 is a sectioned view of a selector valve and check valve for the actuator of FIG. 7;

FIG. 10 is an exploded view of a valve body assembly incorporating the actuator of FIG. 7;

FIG. 11 is a sectioned perspective view of an actuator motor and release drum according to an example embodiment of the present invention;

FIG. 12 is a detail view of the release drum of FIG. 11 shown in a blocking mode;

FIG. 13 is a detail view of the release drum of FIG. 11 shown in a release mode;

FIG. 14 is a schematic view of a transmission system according to the current invention;

FIG. 15 is a perspective view of a valve body assembly;

FIG. 16 is an exploded view of the valve body assembly shown in FIG. 15;

FIG. 17 is a cross-sectional view of a apply actuator;

FIG. 18 is a cross-sectional view of a valve;

FIG. 19 is a cross-section view of a release actuator;

FIG. 20 is a perspective view comparing the release actuator of FIG. 19 in a select position and a release position;

FIG. 21 is a cross-sectional view of a transmission system according to the current invention;

FIG. 22 is a cross-sectioned perspective view of a torque converter of the transmission system shown in FIG. 21;

FIG. 23 illustrates a mounted actuation unit for the transmission system of FIG. 21;

FIG. 24 illustrates a power pack assembly for a transmission system for the transmission system of FIG. 21;

FIG. 25 is a cross-sectional view of a prior art transmission system;

FIG. 26 is a cross-sectional view of a transmission system according to the current invention which eliminates dynamic seals;

FIG. 27 is a cross-sectional view of a transmission system;

FIG. 28 is an enlarged view of the encircled area of the transmission system shown in FIG. 27;

FIG. 29 is a cross-sectional view corresponding to the area of the transmission system shown in FIG. 28, as modified according to the current invention;

FIG. 30 is a cross-sectional view of a check-valve mechanism; and,

FIG. 31 is a cross-sectional view of a transmission system indicating where improvements according to the current invention are generally installed or incorporated in the transmission system.

### DETAILED DESCRIPTION OF THE INVENTION

At the outset, it should be appreciated that like drawing numbers on different drawing views identify identical, or functionally similar, structural element of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

An alternative to replace the high pressure flow from the pump in a typical transmission is to use a hydrostatic system consisting of an electronically controlled master and slave cylinder. Conventional technology would require a separate E-motor and master cylinder for each clutch which may not be practical or cost effective. This invention controls the flow to all clutches with one electronically controlled master cylinder and one electronically controlled release actuator by making use of the mechanism designed to shift lay shaft (manual) transmissions using only one motor (see, U.S. Pat. Nos. 7,026,770 and 7,303,043).

The basic operation of the mechanism described in the above patents uses the two rotation directions of the motor to control the output of the actuator. In one direction the E-motor travels a nut up a lead screw until it reaches the end of it travel at which point the whole mechanism rotates freely. In the other rotation direction a one-way clutch holds the mechanism in the chosen location allowing the nut to travel down the lead screw.

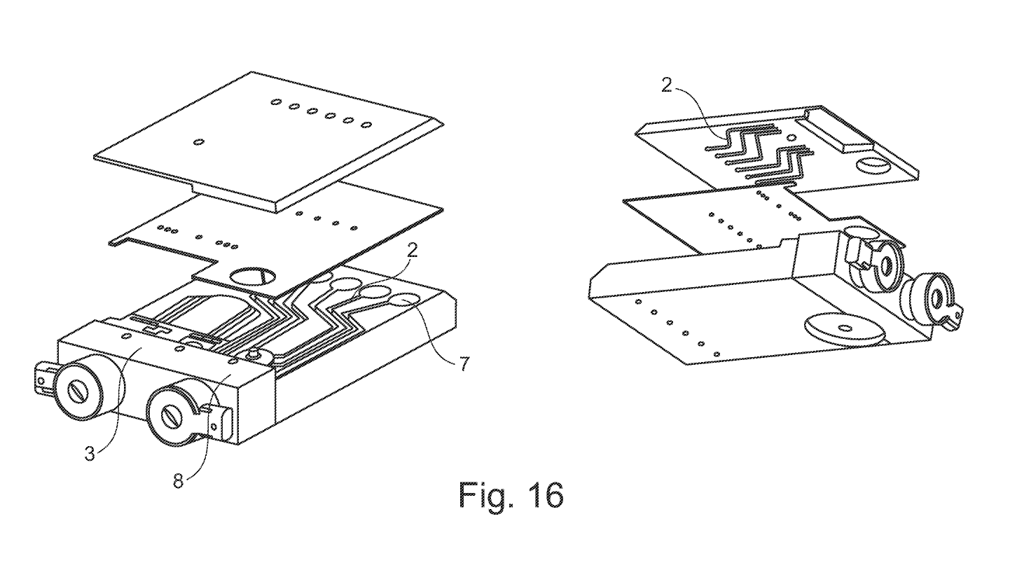

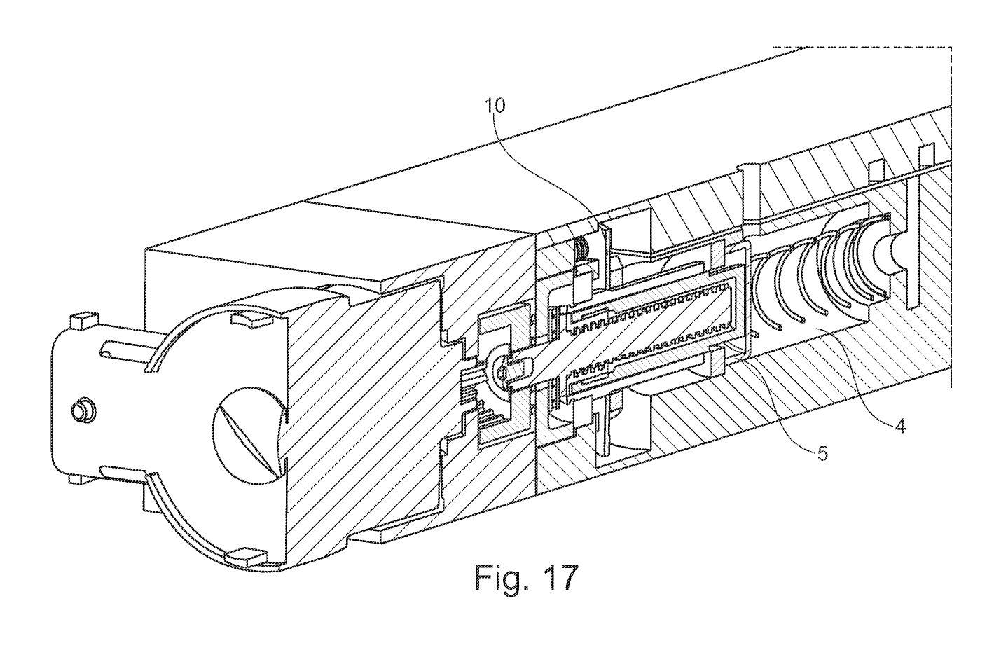

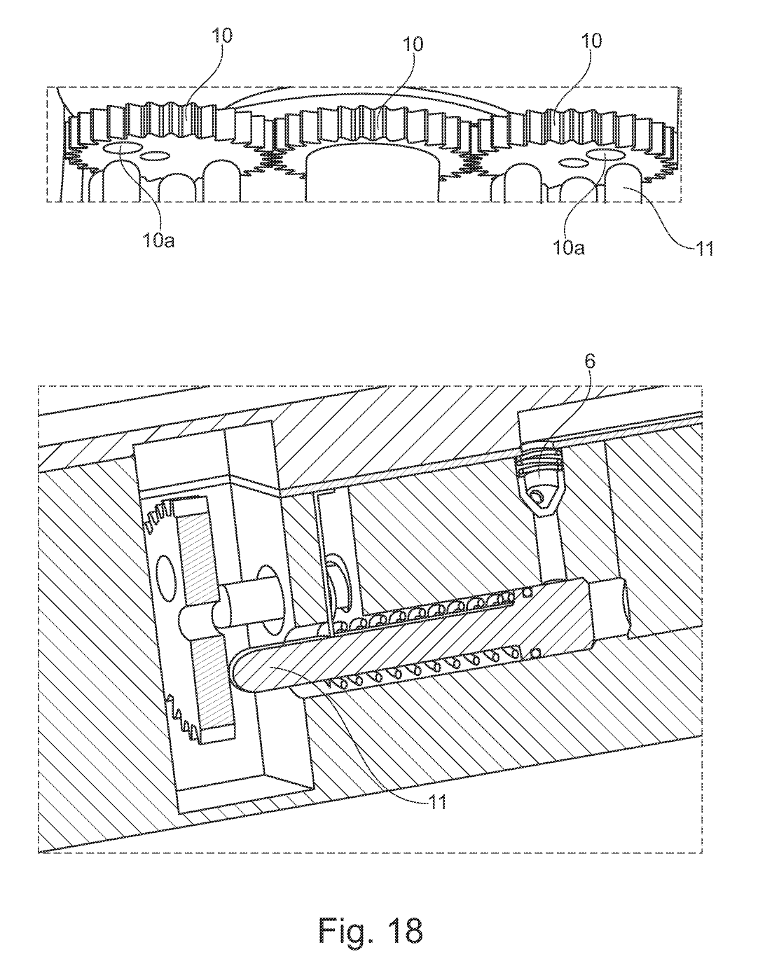

In the present invention, two of the above actuators are built into a common valve body 1 (see FIG. 15) containing the hardware and fluid passageways 2 (FIG. 16) to direct the fluid to the proper location(s). The first actuator is referred to as the apply actuator 3 which controls which passageways are open and runs a master cylinder 4 (FIG. 17) which pressurizes the system. The selecting of various passageways is accomplished by rotating a series of gears 10 with openings 10a (FIG. 18) to allow or restrict movement of valve spools 11. There is one valve spool in each passageway, thus allowing or preventing flow as desired.

In order to permit the actuator to retract the master cylinder piston 5, a one-way valve 6 is included in the system. This allows for recharging of fluid or selecting another passageway for pressurization without permitting the previously engaged clutch or clutches to disengage. Fluid accumulators 7 can also be included into the system as required.

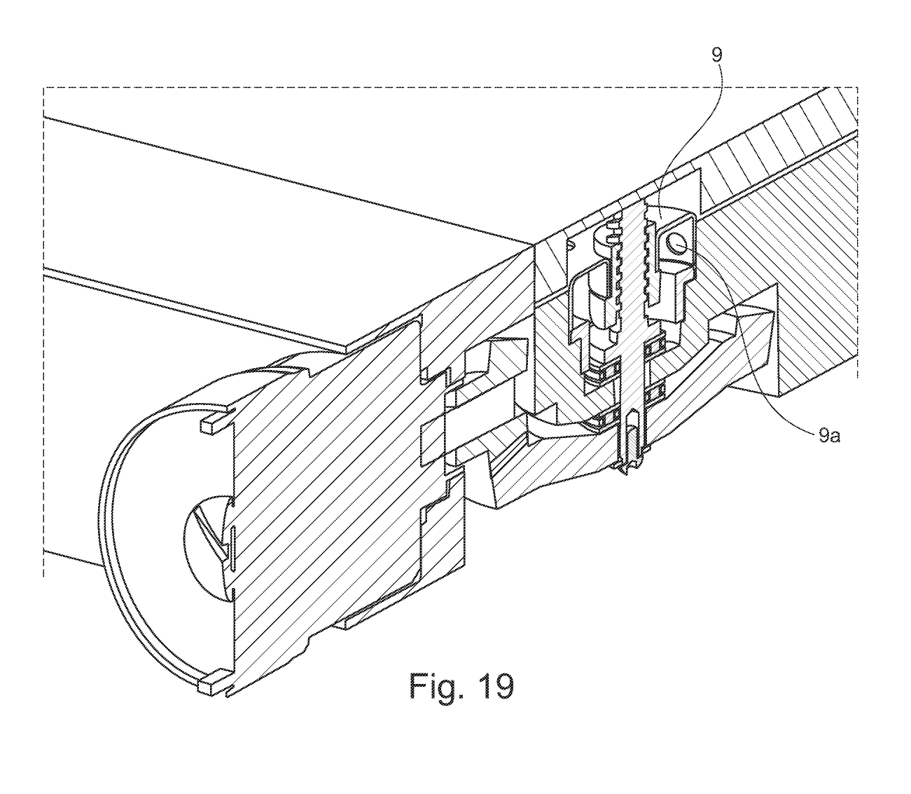

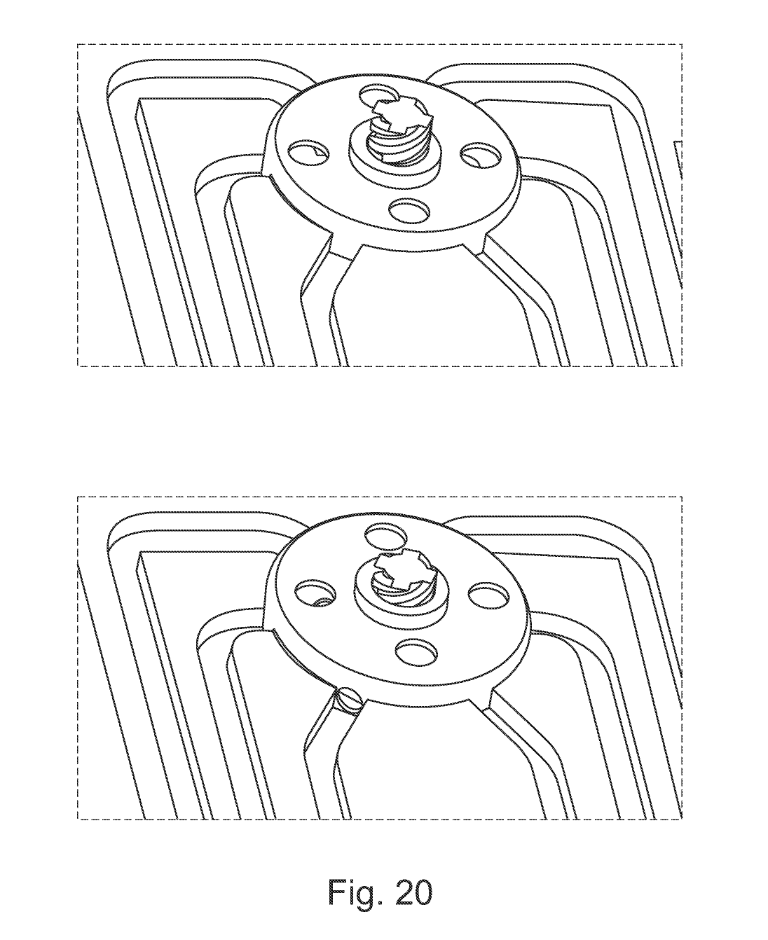

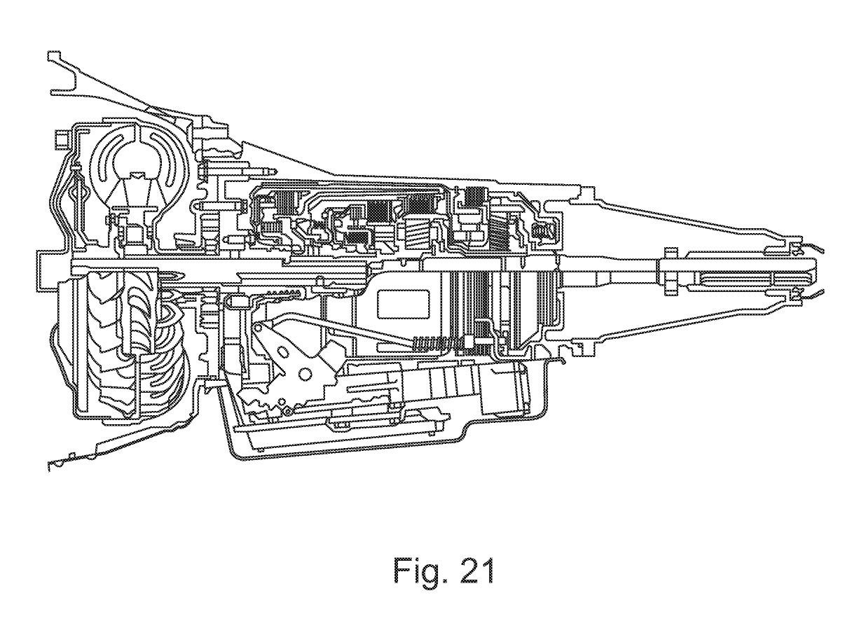

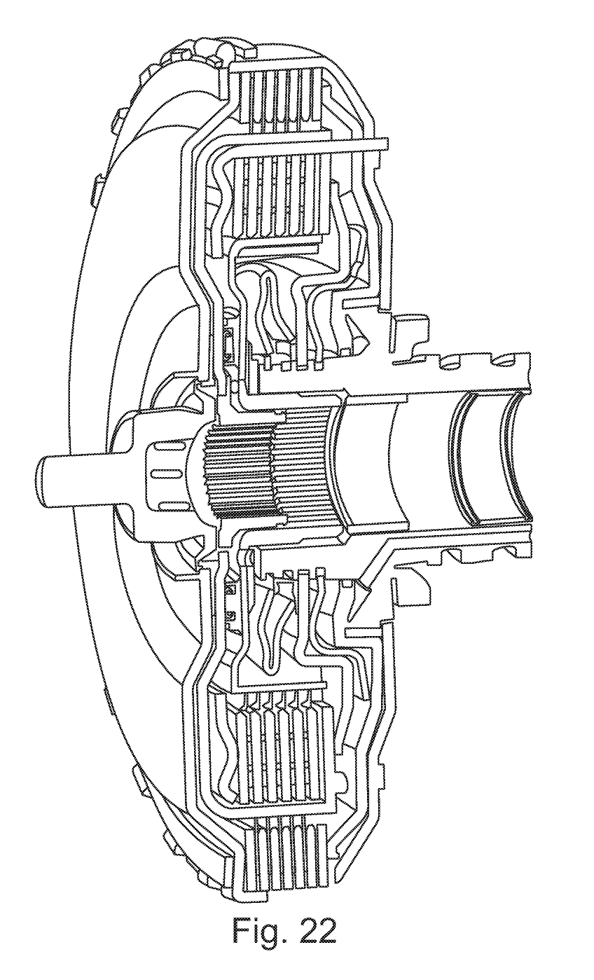

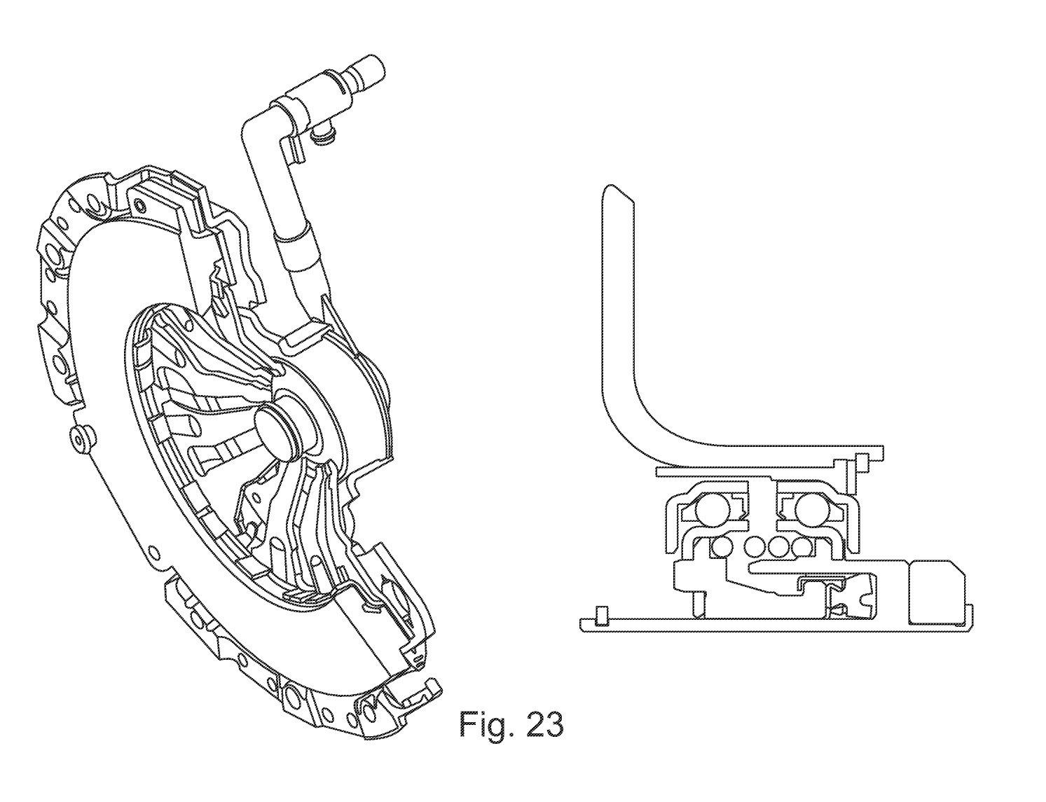

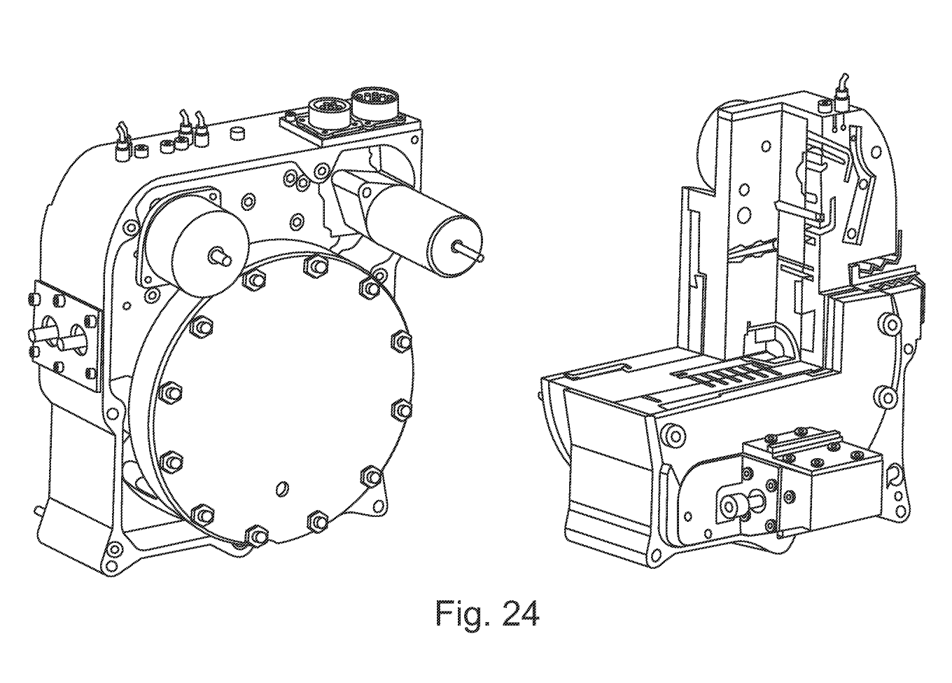

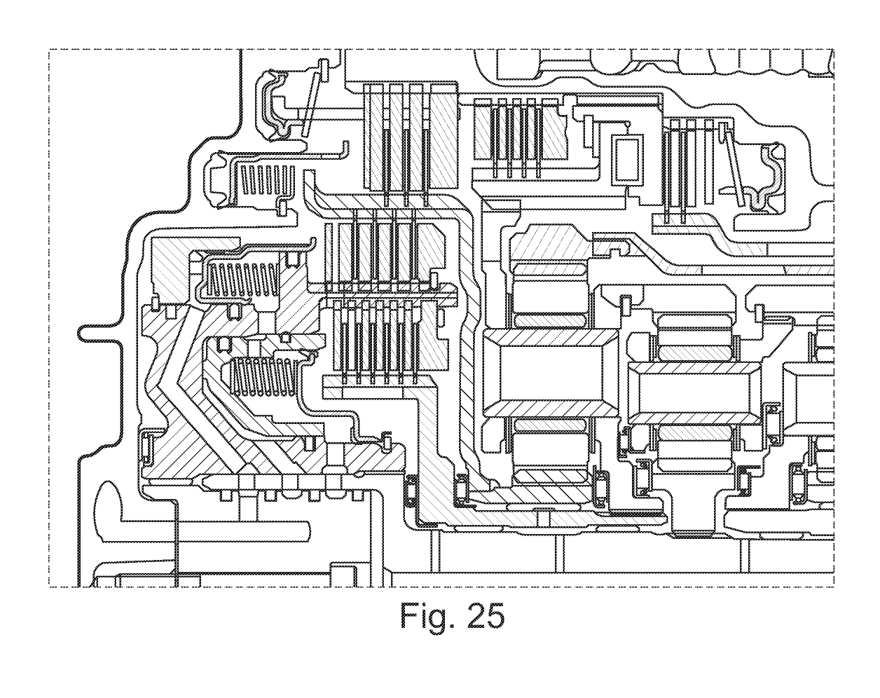

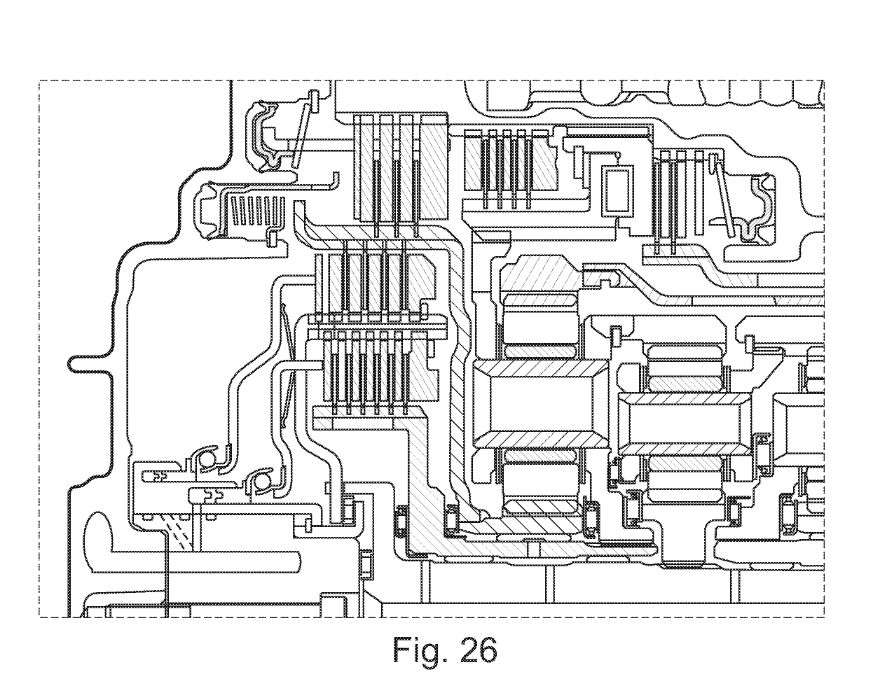

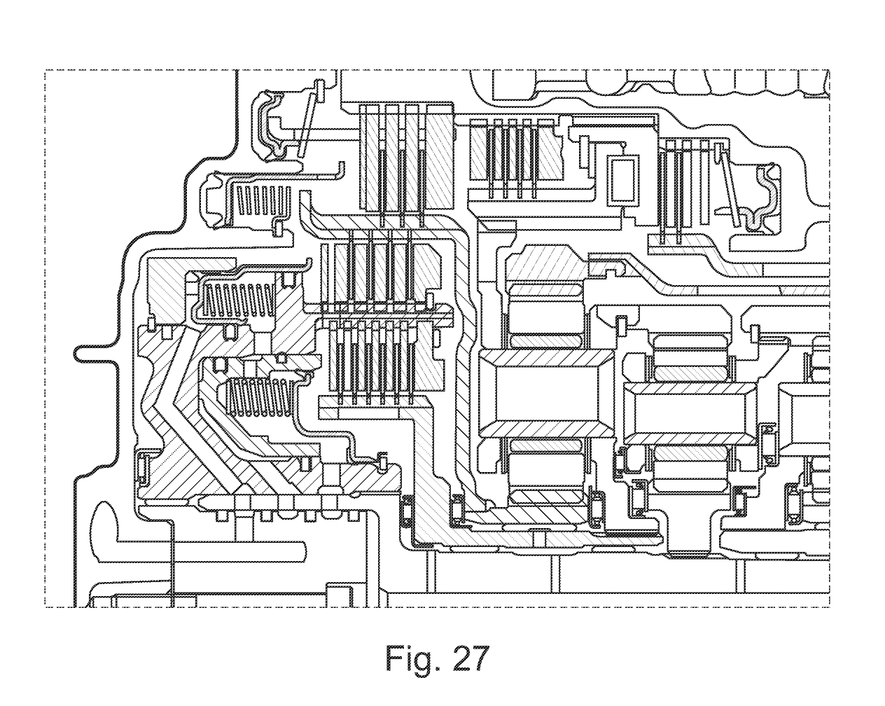

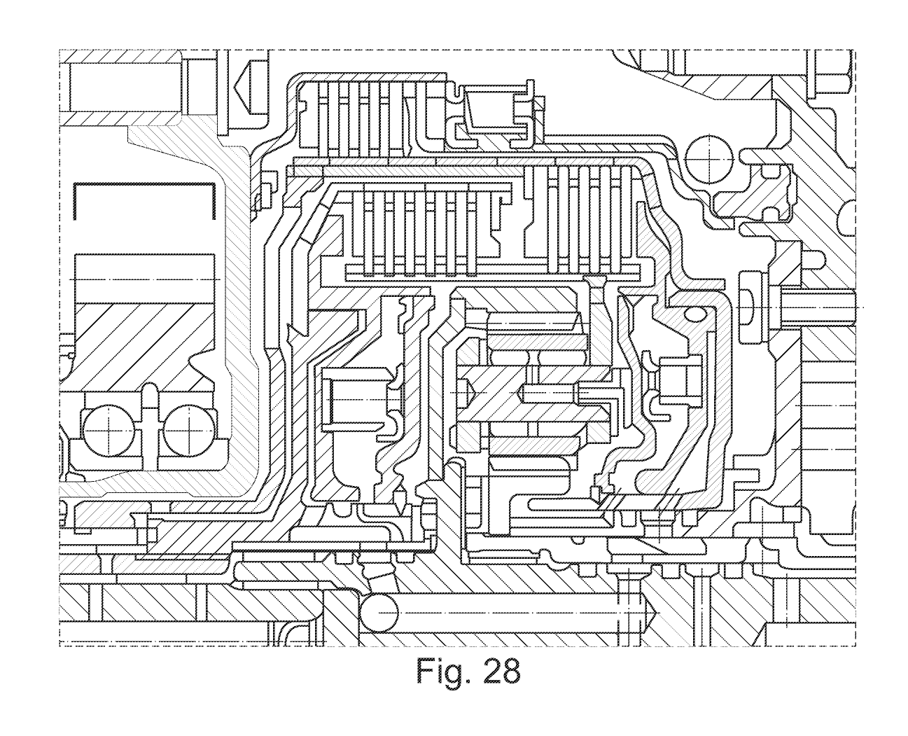

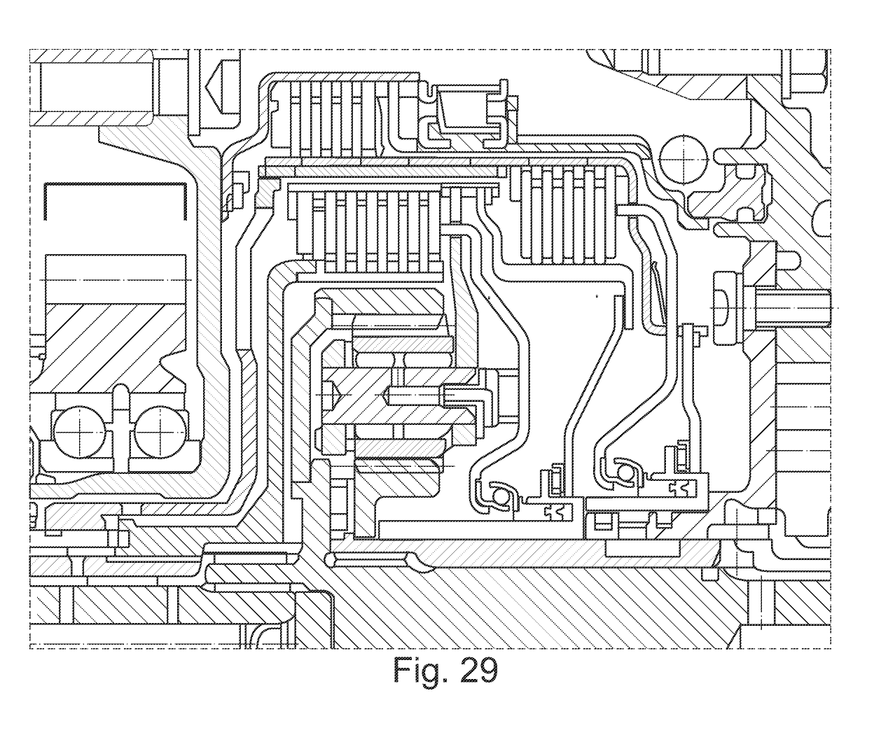

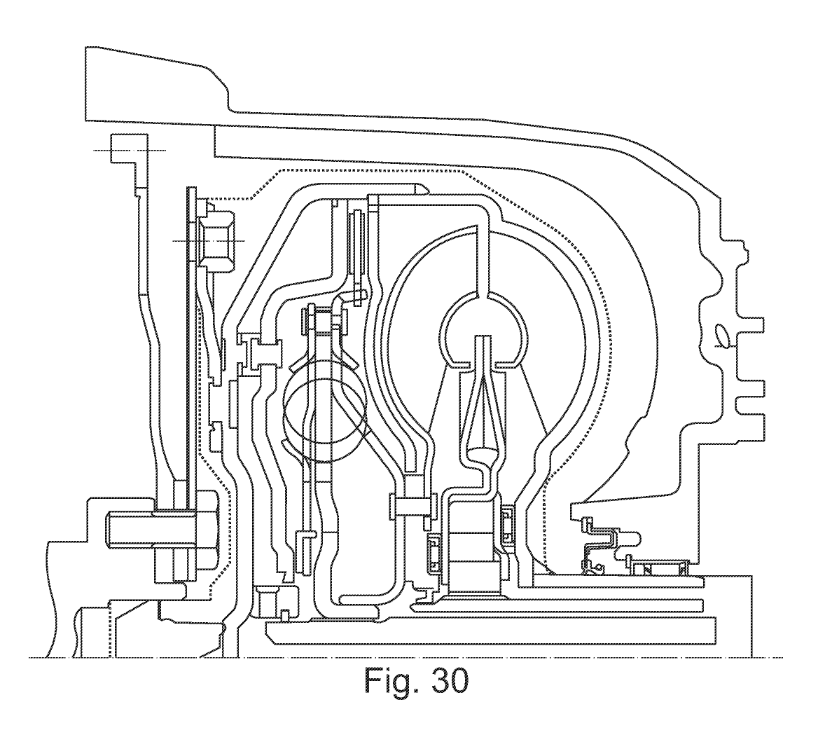

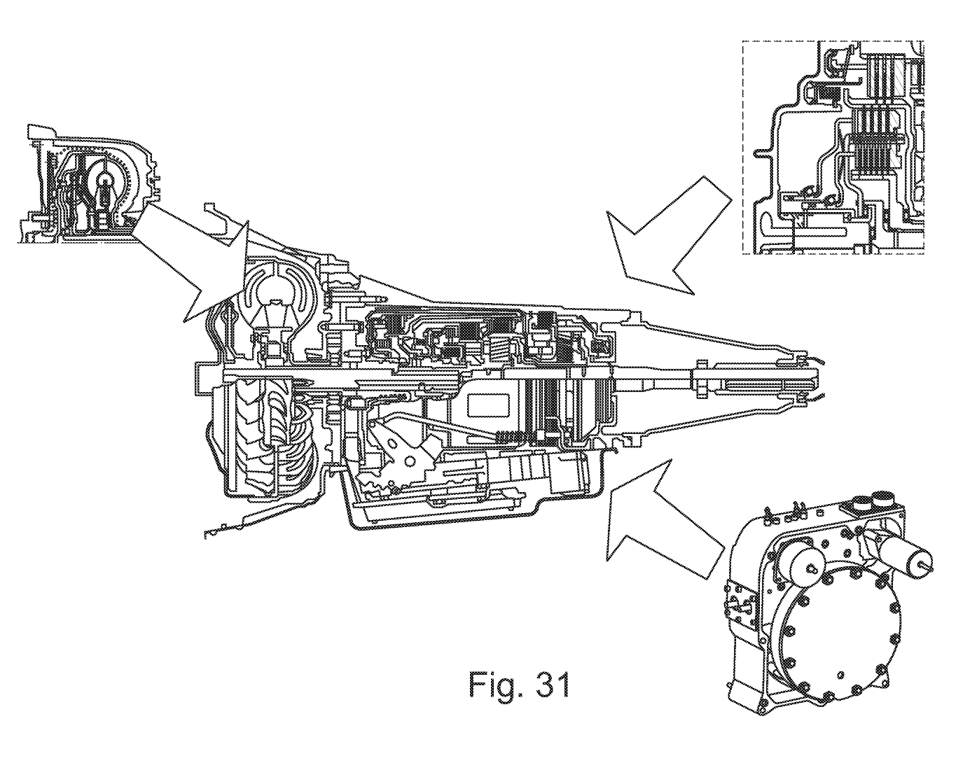

Because of this one-way valve, the fluid cannot return the same way it was applied. Therefore, an alternative flow path for the fluid to return to the sump must be provided. The flow through these return passageways also must be controlled and is accomplished with a second actuator called a release actuator 8. This actuator must seal all passageways during the select process and open the desired passageway(s) in the apply mode. This is accomplished by rotating a cylinder 9 with openings 9a (FIG. 19) corresponding to the available passageways. This release of the clutch is then controlled by how far and how quickly the cylinder 9 is moved into position. This effectively creates a variable size orifice that controls the flow and therefore the characteristics of the clutch disengagement.

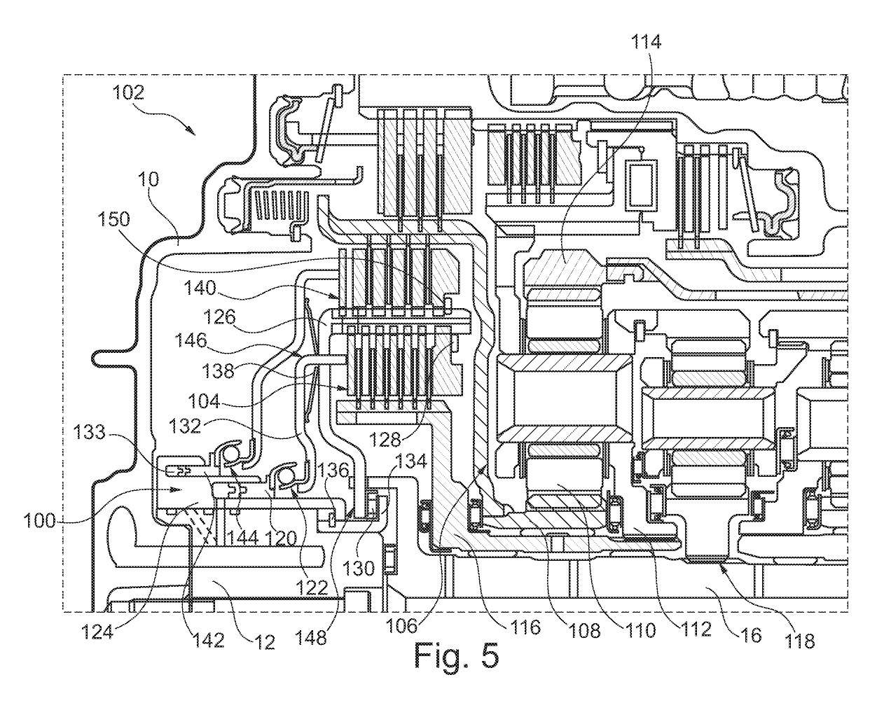

FIG. 5 is a detail view of encircled region 2 with an example embodiment of a present invention actuator. The following description is made with reference to FIG. 5.

Present invention actuator 100 for vehicle transmission 102 includes rotating clutch pack 104 engageable with gear 106. In some example embodiments of the invention, gear 106 is a planetary gearset with sun gear 108, planet gear 110 and carrier 112, and ring gear 114, and output hub 116 of clutch pack 104 is drivingly engaged with carrier 112 at spline 118. Actuator 100 also includes non-rotating actuator piston 120 for engaging clutch pack 104, and bearing 122 for isolating rotation of clutch pack 104 from piston 120. In some embodiments, bearing 122 is a release bearing.

In an example embodiment of the invention, actuator 100 is disposed within housing 10 for transmission 102. In some example embodiments of the invention, piston 120 is disposed in chamber 124, and chamber 124 is rotationally fixed to housing 10 by a key and keyway (not shown), for example. In some example embodiments of the invention, actuator 100 also includes clutch carrier 126. Carrier 126 axially retains clutch pack 104 with snap ring 128, for example. That is, snap ring 128 engaged with carrier 126 prevents axial displacement of clutch pack 104 when axial force is applied to clutch pack 104. Bearing 130 isolates rotation of carrier 126 from chamber 124 and reacts axial force of carrier 126 to chamber 124.

Arrangement of chamber 124, piston 120, bearing 122, clutch pack 104, carrier 126 and bearing 130 isolates rotational motion while minimizing thrust loading. Pressure in chamber 124 exerts force on piston 120 which in turn pushes on bearing 122. Force of bearing 122 is applied to actuator arm 132. Arm 132 rotates with clutch pack 104 and bearing 122 isolates that rotation from piston 120. Therefore, because piston 120 is non-rotating, piston seal 133 does not need to be a dynamic seal and can maintain a liquid-tight connection. Arm 132 applies force to clutch pack 104 which in turn pushes on carrier 126 through snap ring 128. Force of carrier 126 is reacted through bearing 130 to non-rotating portion 134 to chamber 124 through snap ring 136, for example. Because pressure acting on piston 120 is also acting on chamber 124 in the opposite direction, the forces are balanced and the thrust force is minimized.

In an example embodiment of the invention, actuator 100 includes release spring 138 for disengaging clutch pack 104. Disengagement of clutch pack 104 by spring 138 applies a preload to bearing 122.

In some example embodiments of the invention, actuator 100 includes rotating clutch pack 140, non-rotating actuator piston 142 for engaging clutch pack 140, and bearing 144 for isolating rotation clutch pack 140 from second piston 142. In the example embodiment of FIG. 5, clutch pack 140 is disposed radially outside of clutch pack 104. However, other configurations of clutch packs 104 and 140 are possible with the present invention. For instance, clutch pack 104 may be disposed radially inside of clutch pack 140, or clutch pack 104 may be disposed adjacent to clutch pack 140.

In some example embodiments of the invention, clutch carrier 126 is an outer clutch carrier for clutch pack 104 and an inner clutch carrier for clutch pack 140. In an example embodiment of the invention, a portion of actuator arm 132 passes through clearance hole 146 in clutch carrier 126. In an example embodiment of the invention, carrier 126 is rotatably fixed to input shaft 16 for transmission 102 at tabbed connection 148, for example.

In some example embodiments of the invention, carrier 126 axially retains clutch pack 140 by snap ring 150, for example. Bearing 130 reacts axial force of carrier 126 to chamber 124. The earlier discussion of thrust forces for piston 120, bearing 122, and clutch pack 104 is generally applicable for piston 142, bearing 144, and clutch pack 140 and will not be repeated.

Transmission 102 includes gear 106 engaged with rotating clutch pack 104 through output hub 116, for example. Transmission 102 also includes gear actuator 100 with non-rotating actuator piston 120. Bearing 122 isolates rotation of clutch pack 104 from piston 120. In an example embodiment, gear 106 is axially disposed between actuator 100 and an engine drivingly engaged with the transmission (not shown).

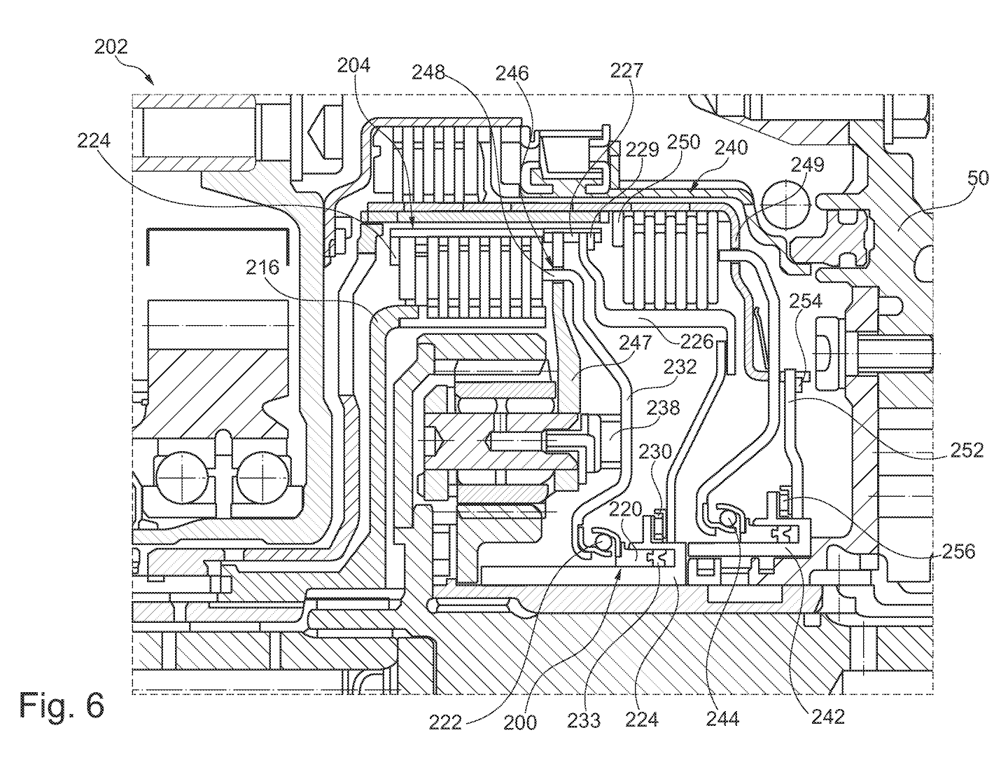

FIG. 6 is a detail view of encircled region 4 with an example embodiment of a present invention actuator. The following description is made with reference to FIG. 6. Present invention actuator 200 for vehicle transmission 202 includes rotating clutch pack 204 engageable with a gear (not shown). In some example embodiments of the invention, gear (not shown) is a planetary gearset and output hub 216 of clutch pack 204 is drivingly engaged with a sun gear of the planetary gearset. Actuator 200 also includes non-rotating actuator piston 220 for engaging clutch pack 204, and bearing 222 for isolating rotation of clutch pack 204 from piston 220. In some embodiments, bearing 222 is a release bearing.

In an example embodiment of the invention, actuator 200 is disposed within housing 50 for transmission 202. In some example embodiments of the invention, piston 220 is disposed in chamber 224, and chamber 224 is rotationally fixed to housing 50 by a key and keyway (not shown), for example. In some example embodiments of the invention, actuator 200 also includes clutch carrier 226 and outer carrier 227. Carriers 226 and 227 axially retain clutch pack 204 with snap rings 228 and 229, for example. That is, snap rings 228 and 229 engaged with carrier 227 prevent axial displacement of clutch pack 204 when axial force is applied to clutch pack 204. Bearing 230 isolates rotation of carrier 226 from chamber 224 and reacts axial force of carrier 226 to chamber 224.

Arrangement of chamber 224, piston 220, bearing 222, clutch pack 204, carriers 226 and 227, and bearing 230 isolates rotational motion while minimizing thrust loading. Pressure in chamber 224 exerts force on piston 220 which in turn pushes on bearing 222. Force of bearing 222 is applied to actuator arm 232. Arm 232 rotates with clutch pack 204 and bearing 222 isolates that rotation from piston 220. Therefore, because piston 220 is non-rotating, piston seal 233 does not need to be a dynamic seal and can maintain a liquid-tight connection. Arm 232 applies force to clutch pack 204 which in turn pushes on carrier 226 through carrier 227 and snap rings 228 and 229. Force of carrier 226 is reacted through bearing 230 to chamber 224. Because pressure acting on piston 220 is also acting on chamber 224 in the opposite direction, the forces are balanced and the thrust force is minimized.

In an example embodiment of the invention, actuator 200 includes release spring 238 for disengaging clutch pack 204. Disengagement of clutch pack 204 by spring 238 applies a preload to bearing 222.

In some example embodiments of the invention, actuator 200 includes rotating clutch pack 240, non-rotating actuator piston 242 for engaging clutch pack 240, and bearing 244 for isolating rotation clutch pack 240 from second piston 242. In the example embodiment of FIG. 6, clutch pack 240 is disposed adjacent to clutch pack 204. However, other configurations of clutch packs 204 and 240 are possible with the present invention. For instance, clutch pack 204 may be disposed radially inside or outside of clutch pack 240, as shown in FIG. 5.

In some example embodiments of the invention, clutch carriers 226 and 227 are an inner clutch carrier for clutch pack 240 and an outer clutch carrier for clutch pack 204, respectively. In an example embodiment of the invention, a portion of actuator arm 232 passes through clearance hole 246 in planet carrier 247, drivingly engaged clutch carrier 226. In an example embodiment of the invention, carrier 226 is rotatably fixed to planet carrier 247 at tabbed connection 248, for example.

In some example embodiments of the invention, carrier 249 axially retains clutch pack 240 by snap ring 250, for example. Connector 252 reacts force of carrier 249 through snap ring 254. Bearing 256 reacts axial force of carrier 226 to chamber 224. The earlier discussion of thrust forces for piston 220, bearing 222, and clutch pack 204 is generally applicable for piston 242, bearing 244, and clutch pack 240 and will not be repeated.

Transmission 202 includes gear (not shown) engaged with rotating clutch pack 204 through output hub 216, for example. Transmission 202 also includes gear actuator 200 with non-rotating actuator piston 220. Bearing 222 isolates rotation of clutch pack 204 from piston 220. In an example embodiment, actuator 200 is axially disposed between a gear (not shown) and an engine drivingly engaged with the transmission (not shown).

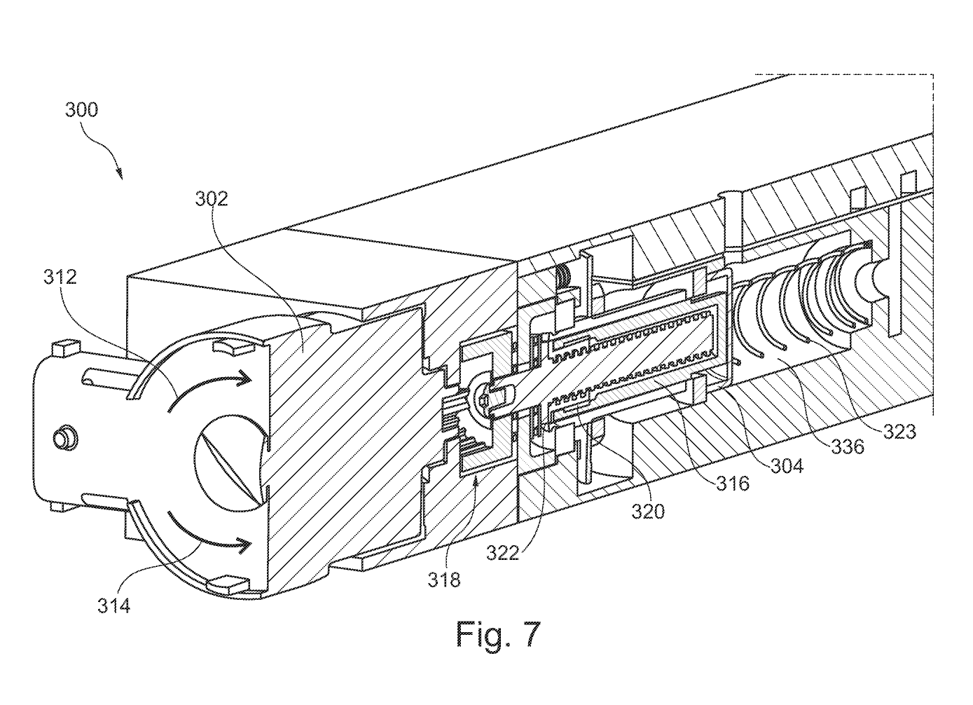

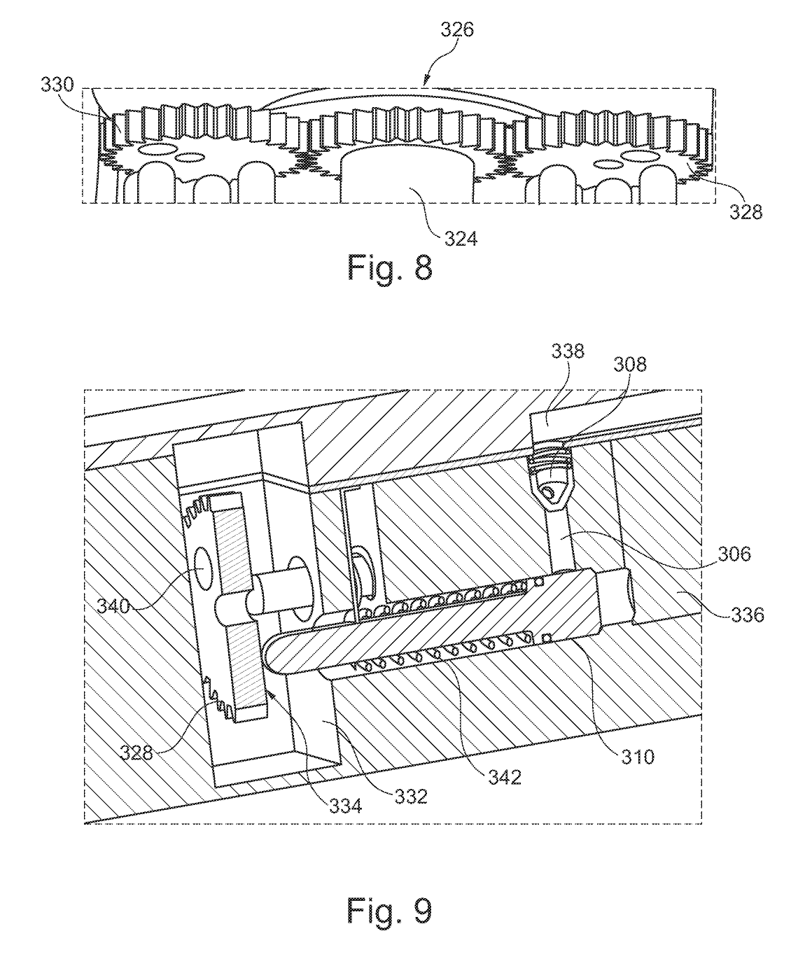

FIG. 7 is a sectioned perspective view of an actuator motor and hydraulic cylinder according to an example embodiment of the present invention. FIG. 8 is a top view of a gear drive for the actuator of FIG. 7. FIG. 9 is a sectioned view of a selector valve and check valve for the actuator of FIG. 7. The following description is made with reference to FIGS. 7-9. Actuator 300 includes electric motor 302 and hydraulic cylinder 304. Channel 306 includes check valve 308 and selector valve 310. Check valve 308 is for maintaining pressure in channel 306 and may be a spring loaded ball in an orifice, for example. Motor 302 is arranged to displace cylinder 304 and operate valve 310 to selectively pressurize channel 306.

In some example embodiments of the invention, rotation of motor 302 in direction 312 displaces cylinder 304 and rotation of motor 302 in direction 314 operates valve 310. Two-way operation of motor-cylinder-valve arrangement is similar to the actuator described in U.S. Pat. Nos. 7,026,770 and 7,303,043, the entire disclosure of which is hereby incorporated by reference herein. Motor 302 is coupled with spindle 316 via gear wheel set 318. When spindle 316 turns, spindle nut 320 can migrate in the longitudinal direction of spindle 316 until it reaches a torsional lock (end stop 322, for example). For example, rotation of motor 302 in direction 312 displaces nut 320 and cylinder 304 to pressurize fluid in chamber 323.

Rotation of motor 302 in direction 314 retracts cylinder 304 until nut 320 reaches stop 322. Once nut 320 reaches stop 322, nut 320 is turned with spindle 316. When disposed against stop 322, nut 320 is drivingly engaged with gear 324 of gear train 326, so rotation of nut 320 also rotates selector gears 328 and 330. Selector gears 328 and 330 control position of valve 310. That is, when pin portion 332 of valve 310 is disposed on annular face 334 of gear 328, valve 310 blocks flow of fluid between chamber 336 and channel 338. When gear 328 is rotated so that pin 332 is aligned with hole 340, pressure in chamber 336 overcomes force of return spring 342 to displace pin 332 into hole 340. As a result, valve 310 is displaced allowing fluid exchange between chamber 336 and channel 338.

Piston chamber 343 and chamber 336 are in fluid communication. Check valve 308 operates to allow flow of fluid from chamber 336 to channel 338, but prevent flow in the reverse direction. Therefore, when cylinder 304 is retracted, fluid in channel 338 remains pressurized.

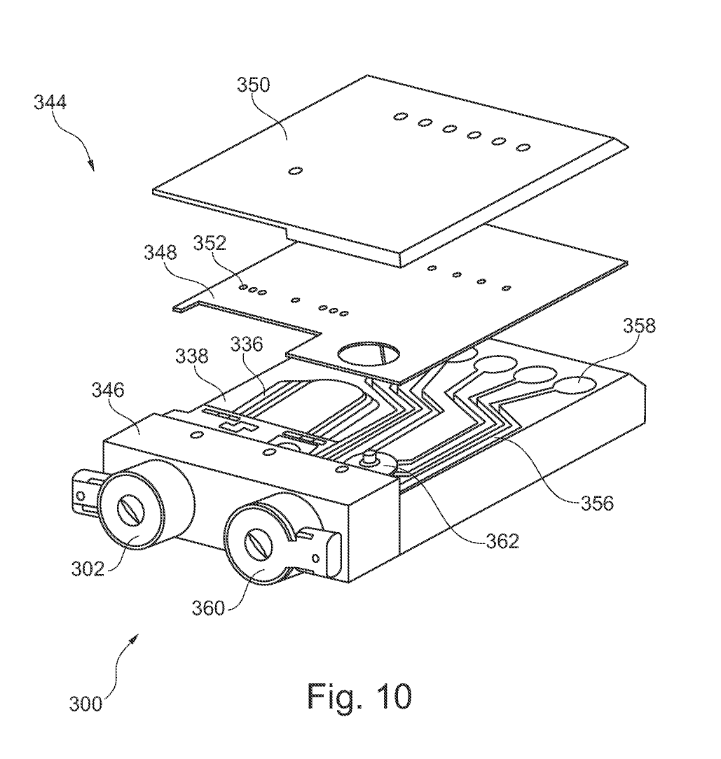

FIG. 10 is an exploded view of a valve body assembly incorporating the actuator of FIG. 7. The following description is made with reference to FIGS. 7-10. Valve body assembly 344 includes valve body 346, gasket 348 and cover 350. Motor 302, cylinder 304, and accumulator 358 are disposed within valve body 346.

Chambers and channels in assembly 344 form a hydraulic path. Pressurized fluid in chamber 336 flows through channel 338 and holes 352 in gasket 348 to channels (not shown) in cover 350. Holes 354 in gasket 348 connect channels in cover (not shown) to return channels 356. Holes 357 in cover 350 connect pressurized fluid with pistons for engaging transmission clutches (pistons 120 and 142, and transmission clutches 104 and 140, for example). In some example embodiments of the invention, accumulator 358 is disposed in channel 356. That is, accumulator 358 disposed after check valve 308 in a hydraulic path beginning at cylinder 304 and chamber 336. In an example embodiment of the invention, accumulator 358 includes a diaphragm spring (not shown).

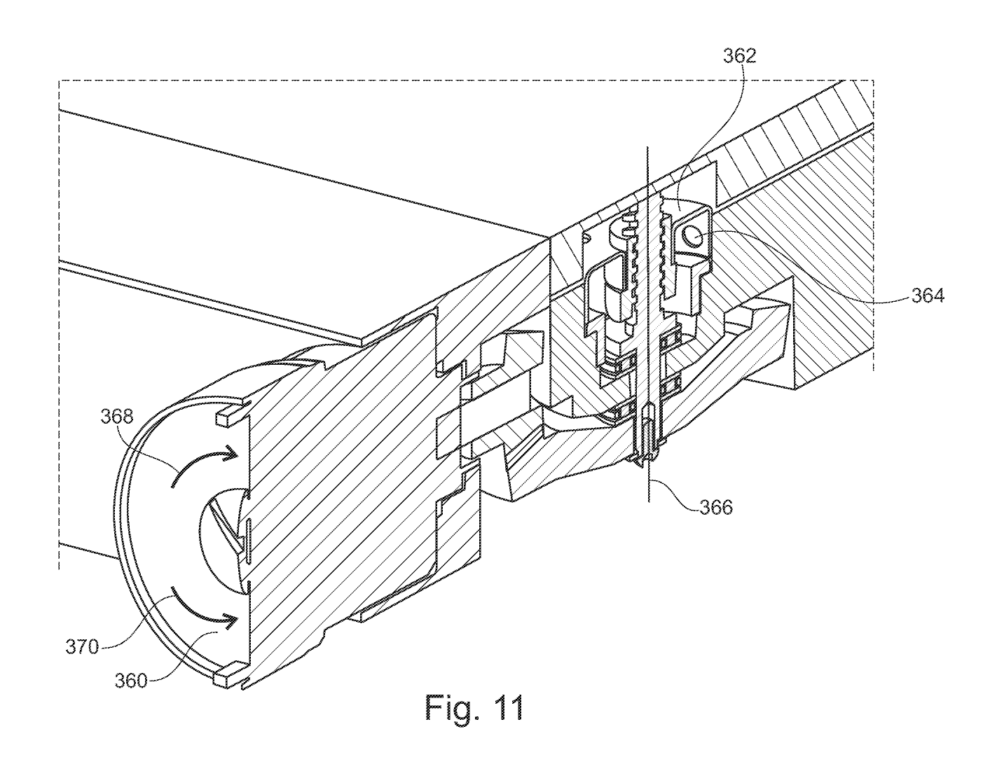

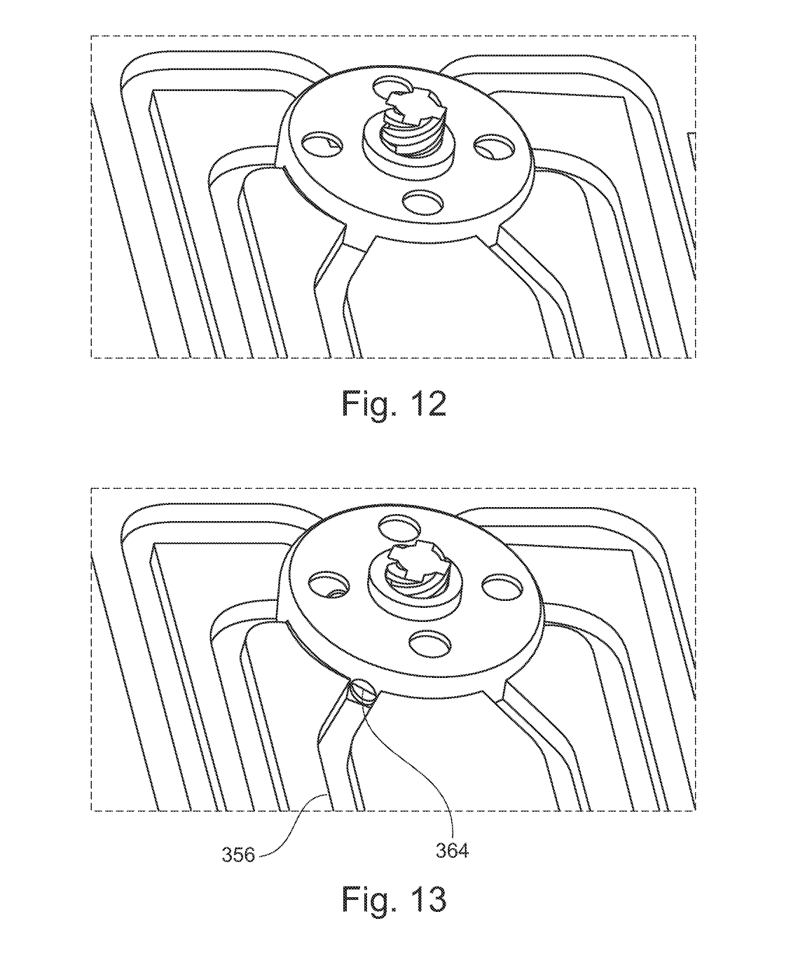

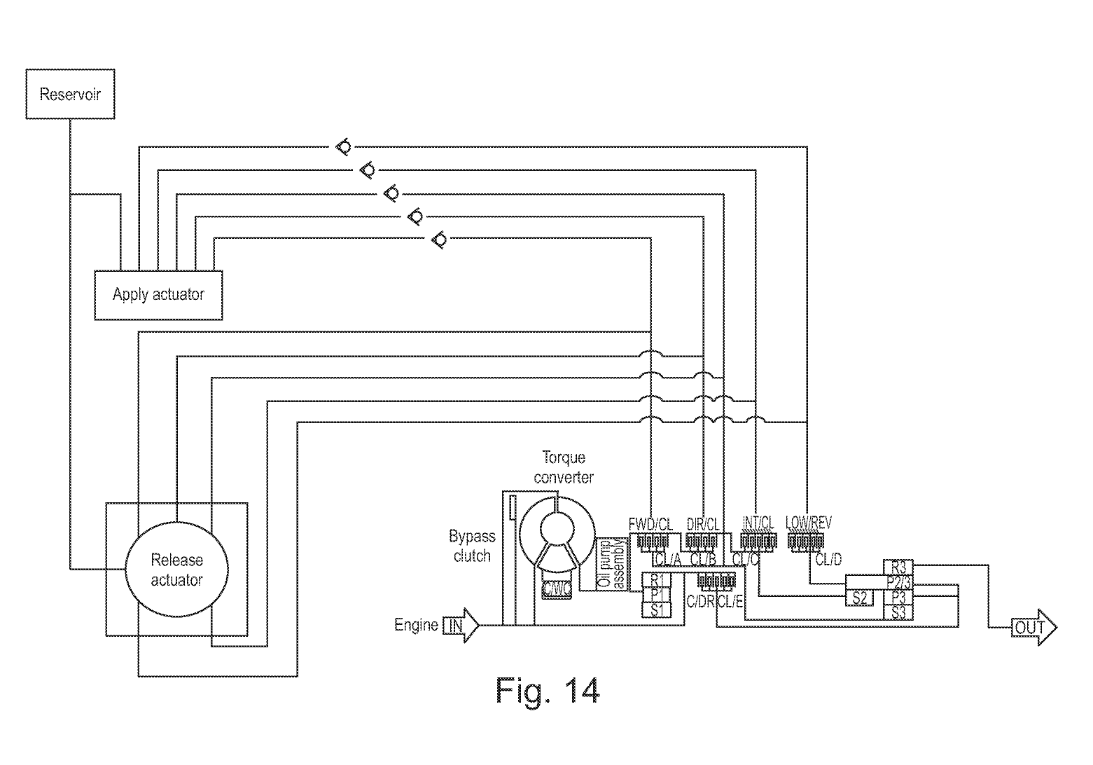

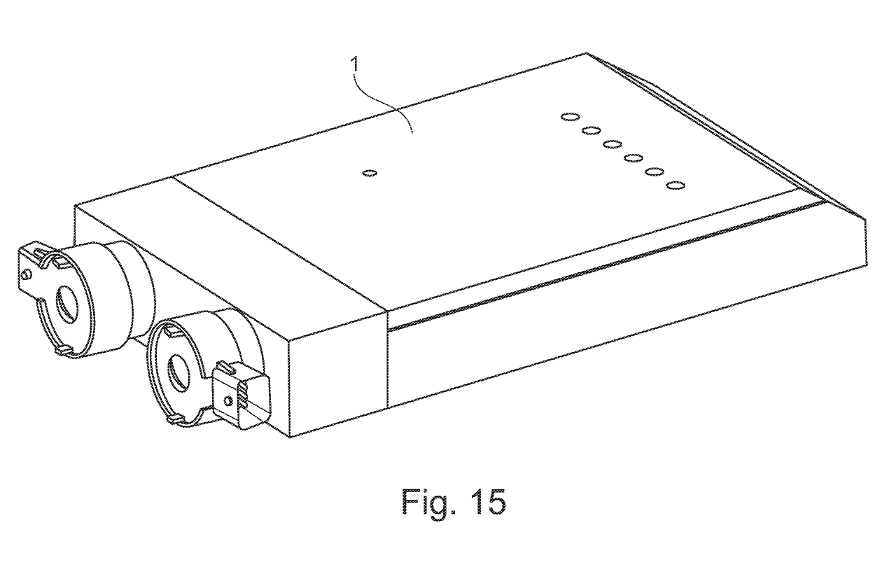

FIG. 11 is a sectioned perspective view of an actuator motor and release drum according to an example embodiment of the present invention. FIG. 12 is a detail view of the release drum of FIG. 11 shown in a blocking mode. FIG. 13 is a detail view of the release drum of FIG. 11 shown in a release mode. The following description is made with reference to FIGS. 10-13. In some example embodiments of the invention, actuator 300 includes electric motor 360 and release drum 362 with release port 364. Motor 360 is arranged to align release port 364 to selectively de-pressurize channel 356.

Drum 362 includes axis 366. Rotation of motor 360 in direction 368 rotates drum 362 about axis 366 and rotation of motor 360 in direction 370 displaces drum 362 along axis 366. Discussion of motor 302 and spindle nut 320 applies to motor 360 and drum 362 and will not be repeated. Rotation of drum 362 circumferentially aligns port 364 with channel 356, but drum 362 must be axially displaced before port 364 can release pressure in channel 356. Therefore, pressure in unselected channels is not released during the selection process. In an example embodiment, motor 360 and drum 362 are disposed in valve body with motor 302, cylinder 304, and accumulator 358.

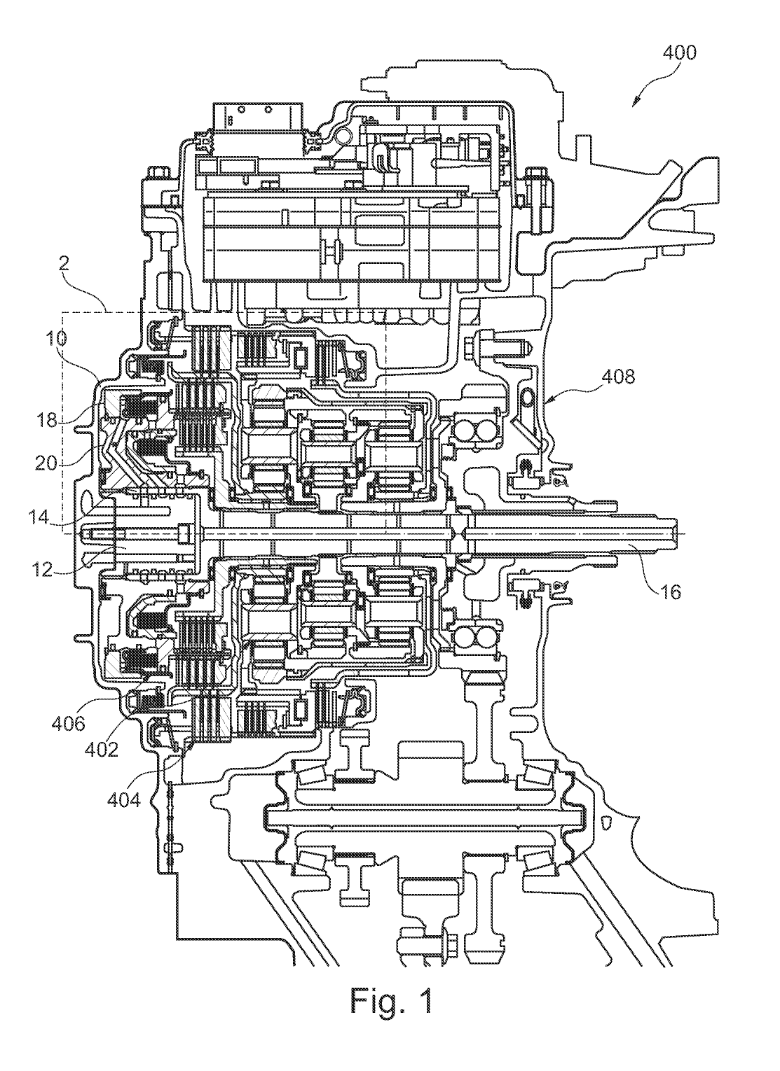

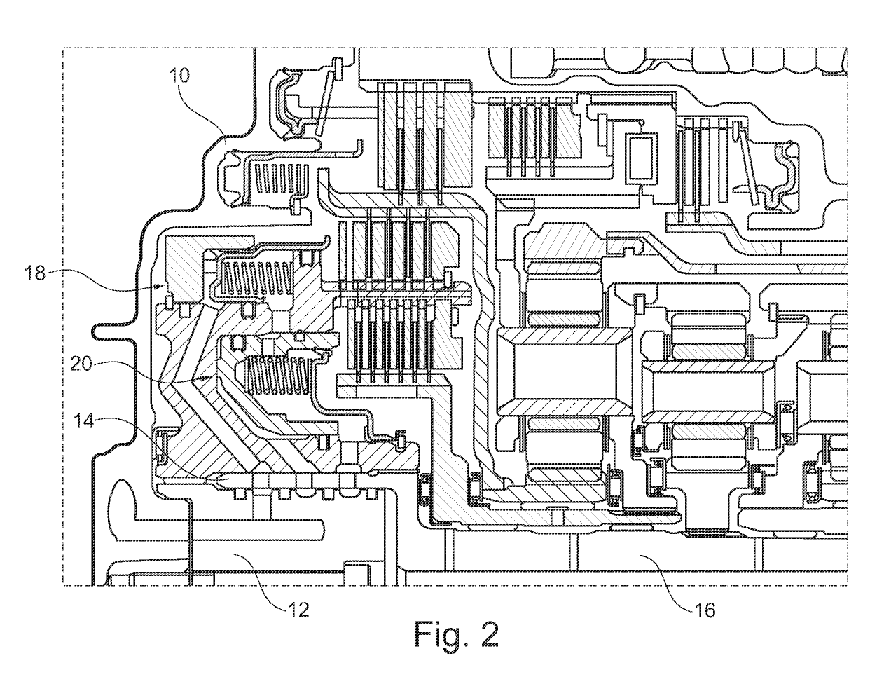

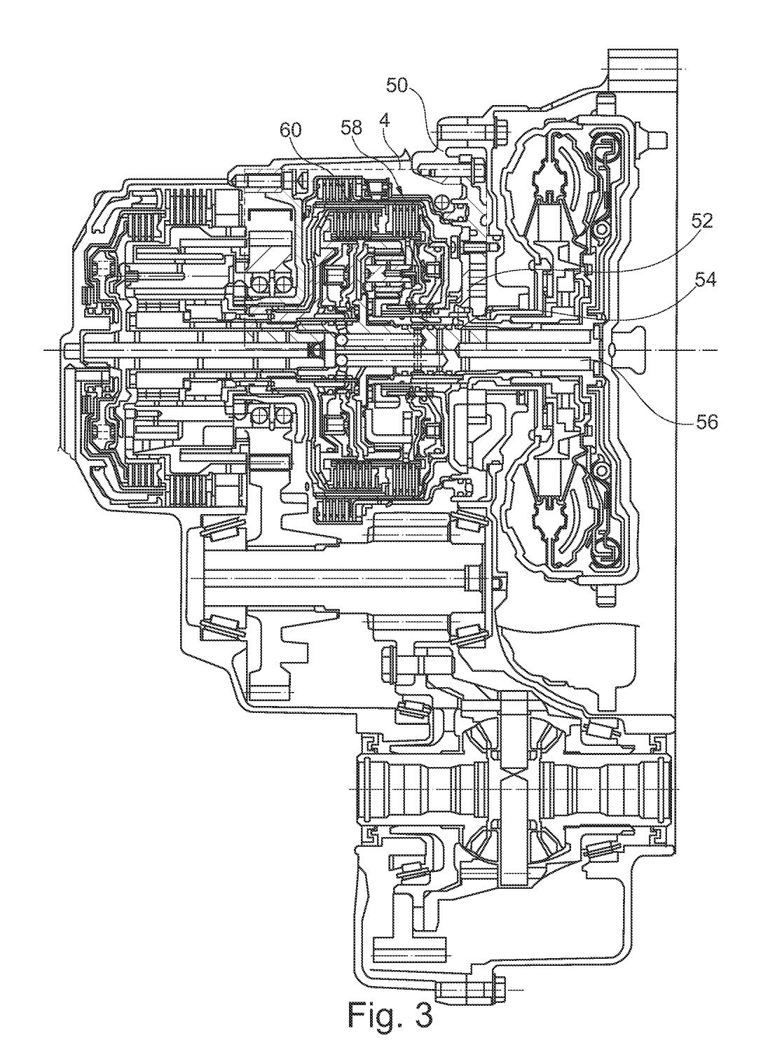

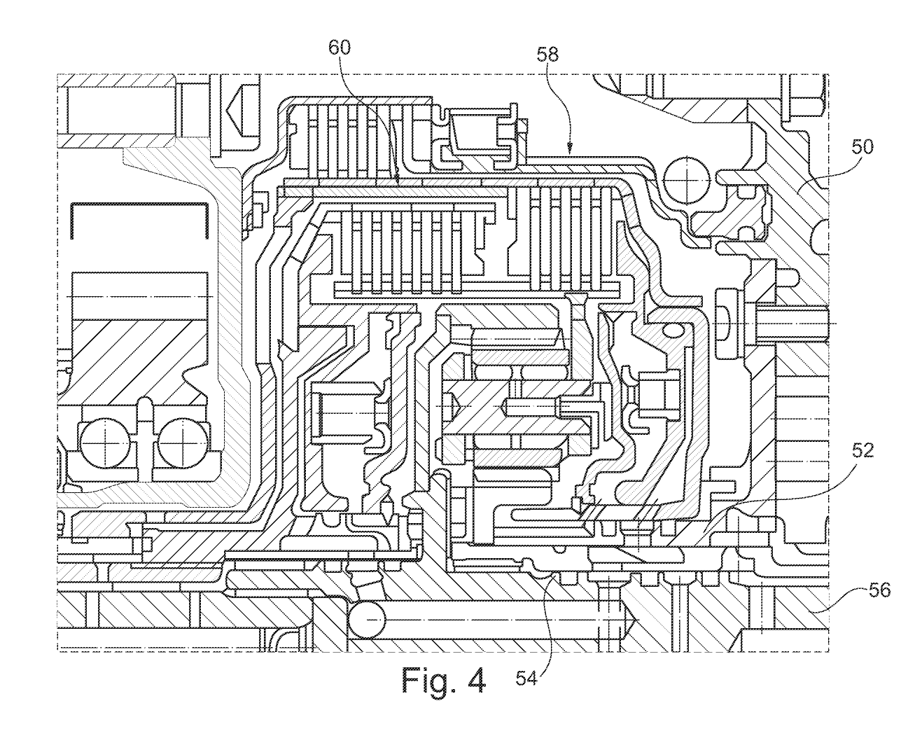

The following description is made with reference to FIGS. 1-13. Example embodiments of the present invention also include a transmission for a vehicle. Transmission 400 (FIG. 1) includes gear 402, brake 404, and clutch 406. Brake 404 and clutch 406 are actuated via individual pressure channels 306 (FIG. 9). Channels 306 each include check valves 308 for maintaining pressure in channels 306. Transmission 400 also includes electric motor 302 (FIG. 11) and hydraulic cylinder 304. Electric motor 302 displaces cylinder 304 to pressurize channels 306.

Transmission 400 includes valve 310 (FIG. 9) operated by motor 302 to selectively pressurize channels 306. Rotation of the motor 302 in direction 312 displaces cylinder 304 and rotation of motor 302 in direction 314 operates valve 310. In an example embodiment, accumulator 358 (FIG. 10) is disposed in a hydraulic path between check valve 308 and brake 404 or clutch 406. Accumulator 358 may include a diaphragm spring.

In an example embodiment of the invention, transmission 400 includes valve body 346 (FIG. 10), and cylinder 304, motor 302, and accumulator 358 are disposed within valve body 346. In some example embodiments of the invention, transmission 400 includes electric motor 360 (FIG. 11) and release drum 362 with release port 364. Motor 360 aligns release port 364 to selectively de-pressurize channels 356. Rotation of motor 360 in direction 368 rotates drum 362 and rotation of motor 360 in direction 370 axially displaces drum 362. In an example embodiment of the invention, transmission 400 includes hydraulic pump 408 for cooling flow. Pump 408 is drivingly engaged with the engine (not shown) for the vehicle.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What we claim is:

1. An actuator for a vehicle transmission comprising:
a first rotating clutch pack engageable with a planetary gearset;
a first non-rotating actuator piston for engaging the clutch pack; and
a first bearing for isolating a first rotation of the clutch pack from the piston.

2. The actuator of claim 1, wherein the actuator is disposed within a housing for the transmission.

3. The actuator of claim 1, wherein the piston is disposed in a chamber rotationally fixed to a housing for the transmission.

4. The actuator of claim 3, further comprising:
a clutch carrier for axially retaining the clutch pack; and
a second bearing for isolating a second rotation of the carrier from the chamber and reacting an axial force of the carrier to the chamber.

5. The actuator of claim 3, further comprising a release spring for disengaging the clutch pack, wherein disengaging the clutch pack applies a preload to the bearing.

6. The actuator of claim 3, further comprising:
a second rotating clutch pack;
a second non-rotating actuator piston for engaging the second clutch pack; and
a second bearing for isolating rotation of the second clutch pack from the second piston.

7. The actuator of claim 6, wherein the second clutch pack is disposed radially outside of the first clutch pack.

8. The actuator of claim 7, further comprising a clutch carrier, wherein the clutch carrier is an outer clutch carrier for the first clutch pack and an inner clutch carrier for the second clutch pack.

9. The actuator of claim 8, further comprising an actuator arm for actuating the first or second clutch pack, wherein at least a portion of the actuator arm passes through a clearance hole in the clutch carrier.

10. The actuator of claim 8, wherein the carrier is rotatably fixed to an input shaft for the transmission.

11. The actuator of claim 8, further comprising a third bearing for isolating a second rotation of the carrier from the chamber, wherein the carrier axially retains the first and second clutch packs and the bearing reacts an axial force of the carrier to the chamber.

12. A transmission comprising:
at least one gear;
at least one rotating clutch pack engageable with the gear;
a gear actuator comprising at least one non-rotating actuator piston; and
at least one bearing for isolating rotation of the clutch pack from the piston, wherein the gear is axially disposed between the actuator and an engine drivingly engaged with the transmission.

13. An actuator comprising:
a first electric motor,
a hydraulic cylinder, and
a channel comprising a check valve for maintaining pressure in the channel, and
a selector valve, wherein the motor is arranged to displace the cylinder and operate the selector valve to selectively pressurize the channel.

14. The actuator of claim 13, wherein rotation of the motor in a first direction displaces the cylinder and rotation of the motor in a second direction operates the selector valve.

15. The actuator of claim 14, wherein the channel further comprises an accumulator disposed after the check valve in a hydraulic path beginning at the cylinder.

16. The actuator of claim 15, wherein the accumulator comprises a diaphragm spring.

17. The actuator of claim 16, further comprising a valve body, wherein the motor, cylinder, and accumulator are disposed within the valve body.

18. The actuator of claim 13, further comprising:
a second electric motor; and
a release drum with a release port, wherein the second motor aligns the release port to selectively de-pressurize the channel.

19. The actuator of claim 18, further comprising an axis for the drum, wherein rotation of the motor in a first direction rotates the drum about the axis and rotation of the motor in a second direction displaces the drum along the axis.

20. The actuator of claim 18, further comprising a valve body, wherein the first motor, cylinder, accumulator, second motor, and drum are disposed within the valve body.

21. A transmission for a vehicle comprising:
at least one gear;
at least one brake; and
at least one clutch, wherein the brake and clutch are actuated via individual pressure channels, the channels each comprising a check valve for maintaining pressure in the channels.

22. The transmission of claim 21, further comprising:
a first electric motor, and
a hydraulic cylinder, wherein the electric motor displaces the cylinder to pressurize at least one channel.

23. The transmission of claim 22, further comprising a valve operated by the motor to selectively pressurize at least one channel.

24. The transmission of claim 23, wherein rotation of the motor in a first direction displaces the cylinder and rotation of the motor in a second direction operates the valve.

25. The transmission of claim 22, wherein at least one channel further comprises an accumulator disposed in a hydraulic path between the check valve and the clutch or brake.

26. The transmission of claim 25, wherein the accumulator comprises a diaphragm spring.

27. The transmission of claim 25, further comprising a valve body, wherein the cylinder, motor, and accumulator are disposed within the valve body.

28. The transmission of claim 22, further comprising:
a second electric motor; and
a release drum with at least one release port, wherein the second motor aligns the release port to selectively de-pressurize at least one channel.

29. The transmission of claim 28, wherein rotation of the motor in a first direction rotates the drum and rotation of the motor in a second direction axially displaces the drum.

30. The transmission of claim 22, further comprising a hydraulic pump for cooling flow, wherein the pump is drivingly engaged with an engine for the vehicle.
